(19) United States
(12) Patent Application Publication
(10) Pub. No.: US 2023/0073810 A1
(43) Pub. Date: Mar. 9, 2023

(54) Opportunistic Creation of Bimodal Avatar Groups

(71) Applicant: AT&T Intellectual Property I, L.P., Atlanta, GA (US)

(72) Inventors: Rashmi Palamadai, Naperville, IL (US); Eric Zavesky, Austin, TX (US); Nigel Bradley, Canton, GA (US)

(73) Assignee: AT&T Intellectual Property I, L.P., Atlanta, GA (US)

(21) Appl. No.: 17/467,489

(22) Filed: Sep. 7, 2021

(51) Int. Cl. G06Q 10/02

(52) U.S. Cl. CPC G06Q 10/02

(57) ABSTRACT

Concepts and technologies disclosed herein are directed to the opportunistic creation of bimodal avatar groups. According to one aspect disclosed herein, a virtual assistant executed by a processor of a user device, can receive an event invitation. The event invitation can identify an event to which a user associated with the user device is invited. The virtual assistant can provide an event RSVP in response to the event invitation. The event RSVP can indicate whether the user plans to attend the event. The event RSVP can also indicate whether the user plans to attend the event in-person or virtually. The virtual assistant can obtain an avatar associated with the user. The avatar can include user identity information that uniquely identifies the user for the event. The virtual assistant can assist the avatar in joining an avatar group that includes a plurality of avatars, including the avatar of the user.

### BACKGROUND

Humans are social animals that need social interactivity for their health and well-being. As technology has progressed, the way in which humans fulfill this need has changed from primarily physical interactions to a combination of physical and virtual interactions through in-person events, social media, video games, video calls, Internet forums, telephone calls, email, text messages, and the like. Social interactions in the virtual world lack a meaningful connection to the physical world and vice versa.

### SUMMARY

Concepts and technologies disclosed herein are directed to the opportunistic creation of bimodal avatar groups. According to one aspect of the concepts and technologies disclosed herein, a user device can include a processor and a memory. The memory can include a virtual assistant comprising instructions that, when executed by the processor, cause the processor to perform operations. In particular, the virtual assistant can receive an event invitation. The event invitation can identify an event to which a user associated with the user device is invited. The event can be any occurrence during which a social interaction takes place among at least two users. The event can be created by a one or more event hosts. The event hosts can be or can include private event hosts such as individuals, groups, educational institutions, and the like. The event hosts can be or can include operators of venues such as stadiums, parks, concert halls, fields, and the like. The event hosts can be social media platforms such as FACEBOOK, INSTAGRAM, TWITTER, Internet forums, and the like. The event hosts can be ticket resellers such as TICKETMASTER. The event hosts can be any other entity or service that can create, at least in part, the event. The event can have a real world component, a virtual world component, or both. During the event the users can share content such as text, audio, video, images, files, software, virtual currency, and the like. The content can include original content created by the users (e.g., text written by the user or a photograph taken by the user). The content can include proprietary content that is subject to digital rights management.

The virtual assistant can provide an event RSVP in response to the event invitation. The event RSVP identifies whether the user plans to attend the event. The event RSVP can also identify whether the user plans to attend the real world component of the event, the virtual world component of the event, or both.

The virtual assistant can obtain an avatar associated with the user. The avatar can include user identity information that uniquely identifies the user for the event. The virtual assistant can assist the avatar in joining an avatar group that includes a plurality of avatars. For example, the virtual assistant can receive collaboration information that identifies a new collaboration opportunity. The new collaboration opportunity can include a collaboration opportunity among a plurality of users associated with the plurality of avatars. The virtual assistant can recommend, to the user, that the user accept the new collaboration opportunity and join the avatar group. The new collaboration opportunity can be based on content such as such as text, audio, video, images, files, software, virtual currency, or the like.

The plurality of avatars in the avatar group can include the avatar of the user and a second avatar of a second user. The avatar can further include a visual representation of the user. The second avatar can include a second visual representation of the second user. The user may attend the real-world component of the event in which the visual representation of the user is presented to the second user in the virtual world component. The second user may attend the virtual component of the event in which the second visual representation of the second user is presented to the user in the real-world component. The second visual representation of the second user can be presented to the user via the user device. The second visual representation of the second user can be presented via a presentation device located within a physical location associated with the event. The second visual representation of the second user can be presented via an augmented reality visualization.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an illustrative operating environment for various concepts and technologies disclosed herein.

FIG. 2 is a flow diagram illustrating aspects of a method for the opportunistic creation of bimodal avatar groups from the perspective of an event management system, according to an illustrative embodiment of the concepts and technologies disclosed herein.

FIG. 3 is a flow diagram illustrating aspects of a method for the opportunistic creation of bimodal avatar groups from the perspective of a virtual assistant executed by a user device, according to an illustrative embodiment of the concepts and technologies disclosed herein.

FIG. 4 is a block diagram illustrating an example computer system capable of implementing aspects of the concepts and technologies disclosed herein.

FIG. 5 is a block diagram illustrating an example mobile device capable of implementing aspects of the concepts and technologies disclosed herein.

FIG. 6 is a block diagram illustrating an example network capable of implementing aspects of the concepts and technologies disclosed herein.

FIG. 7 is a block diagram illustrating an example machine learning system capable of implementing aspects of the concepts and technologies disclosed herein.

FIG. 8 is a block diagram illustrating a virtualized cloud architecture capable of implementing aspects of the concepts and technologies disclosed herein.

### DETAILED DESCRIPTION

The concepts and technologies disclosed herein are directed to the opportunistic creation of bimodal avatar groups. Current methods of social interactivity fail to provide a meaningful connection between the physical and virtual worlds. Moreover, these methods lack the ability to display and rank social contributions in real-time. The concepts and technologies disclosed herein enable a digital link between social interactions (and related data) regardless of whether the interactions occur in the physical world or the virtual world. More specifically, users may take photographs, send text messages, or make purchases during an event, for example, but these choices and media selections may be poorly shared with other participants. The concepts and technologies disclosed herein provide a way through which social content can be ranked, sorted, and recommended for users as needed.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

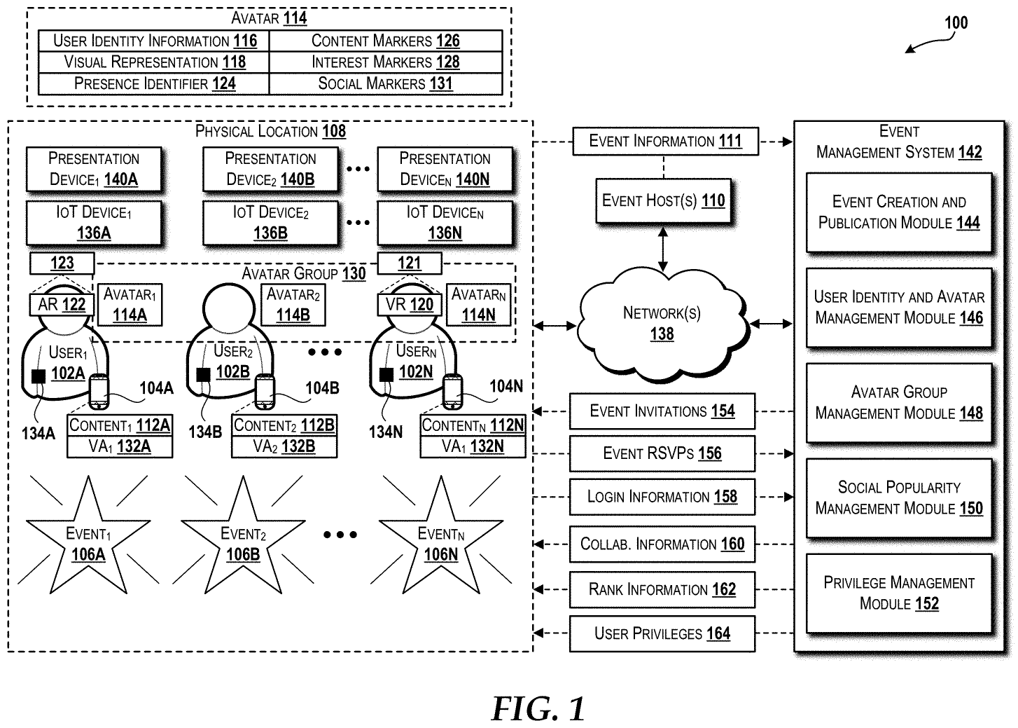

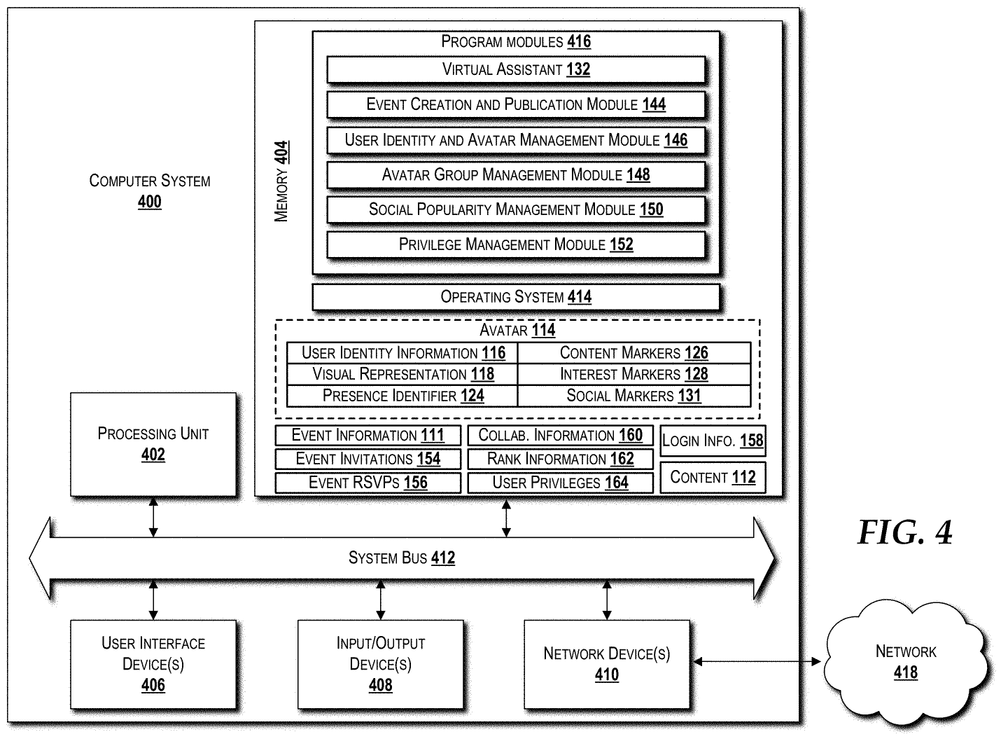

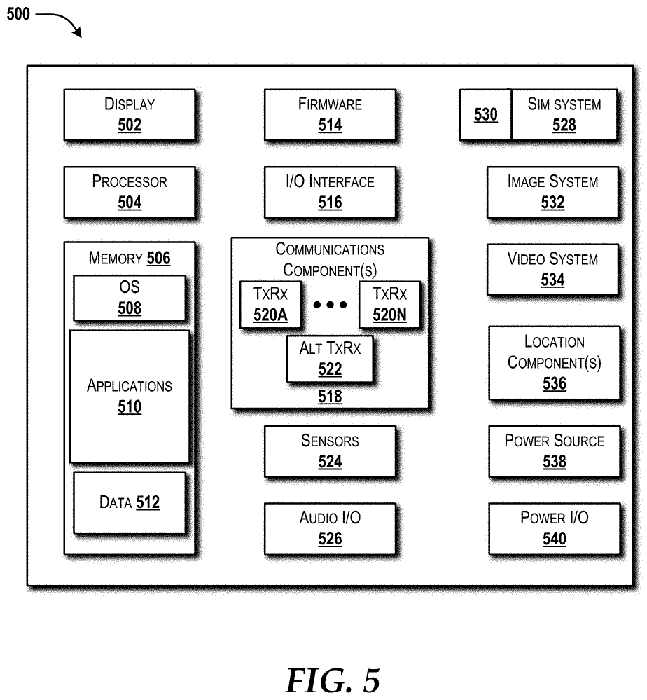

Turning now to FIG. 1, an operating environment 100 in which aspects of the concepts and technologies disclosed herein can be implemented will be described. The operating environment 100 includes a plurality of users 102A-102N (hereafter, at times, referred to collectively as “users 102” or individually as “user 102”), each of whom is associated with at least one of a plurality of user devices 104A-104N (hereafter, at times, referred to collectively as “user devices 104” or individually as “user device 104”), respectively. The user devices 104 can include smartphones, tablets, personal computers, smart devices (e.g., watches, fitness devices, and the like), and the like. In some embodiments, the user device 104 is configured the same as or similar to a computer system 400 described herein with reference to FIG. 4. In some other embodiments, the user device 104 is configured the same as or similar to a mobile device 500 described herein with reference to FIG. 5.

In the illustrated example, the users 102 are attending at least one of a plurality of events 106A-106N (hereafter referred to collectively as “events 106” or individually as “event 106”) held, at least in part, in a physical location 108. The events 106 can be any occurrence during which a social interaction takes place among at least two of the users 102, including physical and virtual users. The events 106 can be created by one or more of the users 102. The events 106 additionally or alternatively can be created by one or more event hosts 110 (hereafter referred to collectively as “event hosts 110” or individually as “event host 110”). The event hosts 110 can be or can include private event hosts such as individuals, groups, educational institutions, and the like. The event hosts 110 can be or can include operators of venues such as stadiums, parks, concert halls, fields, and the like. The event hosts 110 can be social media platforms such as FACEBOOK, INSTAGRAM, TWITTER, Internet forums, and the like. The event hosts 110 can be ticket resellers such as TICKETMASTER. The event hosts 110 can be any other entity or service that can create, at least in part, one or more of the events 106.

The events 106 can be generalized to the physical location 108. The physical location 108 can be defined by longitude and latitude coordinates, a physical address, or a geo-fence. In some embodiments, any of the users 102 who enter a geo-fence surrounding the physical location 108 can attend the event 106. Alternatively, the users 102 may need an invitation to attend the event 106 so that only invited users 102 within the physical location 108 can attend and other users 102 who were not invited cannot attend in the event 106.

The events 106 can be associated with event information 111. The event information 111 can define details about the events 106 such as date(s), start times(s), end time(s), duration(s), location(s) (e.g., the physical location 108), physical attendees, virtual attendees, and/or other information associated with the events 106. The events 106 can be predetermined before the users 102 arrive at the physical location 108. The events 106 can be determined in an adhoc manner when the users 102 are within the physical location 108.

The events 106 can have a real world component and the users 102 can interact with each other face-to-face. The events 106 can additionally have a virtual world component and the users 102 can interact with digitally such as to share content 112. In the illustrated example, the user₁ 102A can share content₁ 112A via the user device₁ 104A; the user₂ 102B can share content₂ 112B via the user device₂ 104B; and the user_{N} 102N can share content_{N} 112N via the user device_{N} 104N. The content 112 can include text, audio, video, images, files, software, virtual currency, and the like. The content 112 can include original content created by the users 102 (e.g., text written by the user 102 or a photograph taken by the user 102). The content 112 can include proprietary content that is subject to digital rights management.

The users 102A-102N are associated with bimodal avatars 114A-114N, respectively (hereafter, at times, referred to collectively as “avatars 114” or individually as “avatar 114”). The avatars 114 provide a virtual representation of and information about the users 102. The avatars 114 can be used in both the real-world and one or more virtual worlds, and therefore can be referred to as bimodal.

The avatars 114 can include user identity information 116 that uniquely identifies the users 102 for interactions in the real world and/or the virtual world. The users 102 can have different user identity information 116 for real world interactions and virtual world interactions. The users 102 can establish one or more rules under which the user identity information 116 can be shared. For example, the user₁ 102A may be comfortable sharing their real name (e.g., “John Doe”) with the other users 102B-102N, but the user₂ 102B may not be comfortable sharing their real name and instead choose to share a virtual name (e.g., screen name, handle, avatar name, or the like). The users 102 may determine with whom their real name can be shared and with whom their real name cannot be shared.

The avatars 114 can also include a visual representation 118. The visual representation 118 can be a photograph, an image, a character, or the like. The visual representation 118 can be still or animated. The visual representation 118 may be interactive such as a playable character. The avatars 114 can include different visual representations 118 for different events 106, interactions, and/or other scenarios.

The users 102 can attend the event 106 virtually and/or physically in-person within the physical location 108. For purposes of explanation, and not limitation, the user₁ 102A and the user₂ 102B will be described as being in-person attendees of the event 106 held in the physical location 108, and the user_{N} 102N will be described as being a virtual attendee of the event 106. Moreover, although only a single event 106 may be described herein, it is contemplated that any of the users 102 may attend any number of events 106, including physically, virtually, or both. The physical and virtual attendees can interact through extended reality (“XR”) technologies such as augmented reality (“AR”) and/or virtual reality (“VR”).

In the illustrated example, the user_{N} 102N, who is attending the event 106 virtually, can use a VR device 120 to explore a VR environment 121. The VR device 120 can be or can include a display (e.g., an integrated display, a head-mounted display, an eyeglasses display, a head-up display, an external monitor, or a projection system), an input device, a combination thereof, or the like. In some embodiments, the VR device 120 is OCULUS RIFT (available from FACEBOOK), GOOGLE CARDBOARD (available from GOOGLE), HTC VIVE (available from HTC), PLAYSTATION VR (available from SONY), or the like. The VR device 120 can be a standalone device or can be in communication (e.g., via wired and/or wireless connection) with the user device 104N to enable or enhance certain functionality of the VR device 120. For example, the VR device 120 may be a headset that relies, at least in part, on the processing capabilities of the user device_{N} 104N to function. Alternatively, the VR device 120 may be a headset that includes one or more processing components to function as a standalone device.

The VR environment 121 can include a computer-generated representation or at least an approximation of at least a portion of a physical real world environment, such as the physical location 108. The visual representations 118 of the avatars 114 can be presented in context of the VR environment 121. The VR environment 121 can include a virtual world that is not tied to any portion of a physical real world environment. The VR environment 121 can include virtual objects not found in the corresponding physical real world environment. Lighting effects such as light bloom and other effects such as depth-of-field can be applied to the VR environment 121 to create atmosphere. Moreover, natural physics such as gravity and momentum can be simulated in the virtual environment 121. These natural phenomena can be simulated, for example, when the user_{N} 102N interacts with the VR environment and/or the other users 102A-102B. Unnatural physics can be simulated in the virtual environment 121.

In the illustrated example, the user₁ 102A, who is attending the event 106 in-person, can use an AR device 122 (shown as “AR 122”) to explore the physical location 108 that has been augmented to include one or more AR visualizations 123. The AR visualizations 123 can be presented over (e.g., as an overlay) and/or spatially integrated with real world objects and/or people in the physical location 108. The AR device 122 can utilize a camera component that is integrated into the AR device 122 or part of the user device 104A to capture a live view of the physical real world environment to be augmented with the AR visualization(s) 123. In some embodiments, the AR visualization(s) 123 can be or can include the visual representations 118 of the avatars 114.

The VR device 120 and the AR device 122 can be in communication with respective user devices 104A, 104N via a wireless or wired connection through which data, such as the content 112, can be shared. As noted above, the VR device 120, the AR device 122, or both can function as a stand-alone system with on-board computing components to perform operations to present AR and VR environments and to facilitate the manipulation thereof.

The avatars 114 can also include a presence identifier 124 that is used to mark the users 102 as physical and/or virtual attendees of the event 106. The presence identifier 124 can include one or more text strings, one or more images, one or more sounds, one or more emoji, a combination thereof, and/or the like. In some embodiments, the presence identifier 124 may appear as an AR visualization 123 associated with the user 102. For example, the user₁ 102A may view, via the AR device 122, the presence identifier 124 associated with the avatar₂ 114B of the user₂ 102B. In some other embodiments, the presence identifier 124 may appear in the VR environment 121. For example, the user_{N} 102N may view, via the VR device 120, the visual representations 118 and the presence identifiers 124 associated with the avatars₁₋₂ 114A-114B of the users₁₋₂ 102A-102B.

The avatars 114 can also include one or more content markers 126 used to identify the content 112 created by the users 102. The content markers 126 can additionally or alternatively identify the content 112 with which the users 102 have interacted. For example, the content markers 126 can identify specific media (e.g., song, movie, other audio, and/or other video) that the users 102 have played in the past or are currently playing. The content markers 126 can identify general media types such as music or movie. The content markers 126 can identify a sentiment expressed in the content 112, such as music described as being upbeat, slow, sad, happy, and so forth.

The avatars 114 can also include one or more interest markers 128 used to identify any interests the users 102 have. The interest markers 128 can be shared via the avatar 114 so the users 102 can identify who has the same or similar interests. For example, the user₂ 102B may view the avatar₁ 114A of the user₁ 102A to identify whether the interest markers 128 in the avatar₁ 114A indicate a common interest shared between the users 102A, 102B. As will be described below, this process can be performed to form an avatar group 130 that contains two or more of the avatars 114 based upon information, such as the interest markers 128, contained in the avatars 001.

The avatars 114 can also include one or more social markers 131 used to identify one or more social media sources that contain information about the users 102. For example, the social marker 131 can indicate that the user₁ 102A associated with the avatar₁ 114A has an account with a social media platform such as FACEBOOK, INSTAGRAM, TWITTER, or the like. A social media account can identify interests used to populate the interest markers 128. The social markers 131 can additionally or alternatively identify social status such as celebrity or popularity in context of the event 106, within a specific avatar group 130, or broader celebrity such as a movie star or a famous musician. In some embodiments, the level of celebrity or popularity can be identified via a ranking system. The social markers 131 can also identify leaders and/or other individuals of interest within avatar groups or sub-groups thereof.

Each of the user devices 104A-104N can execute, via one or more processing components (best shown in FIGS. 4 and 5), a virtual assistant (shown as “VA”) 132A-132N, respectively (hereafter, at times, referred to collectively as “virtual assistants 132” or individually as “virtual assistant 132”). In some embodiments the virtual assistants 132 are native applications stored on and executed by the processing component(s) of the user devices 104. In some other embodiments, the virtual assistants 132 are web applications accessible via a website. The virtual assistants 132 can provide a user interface through which the users 102 can create, modify, delete, or otherwise interact with the avatars 114. The virtual assistants 132 can access communication components of the user devices 104 (e.g., BLUETOOTH, WI-FI, cellular, and/or the like) to create, maintain, and tear down connections among two or more of the user devices 104. The virtual assistants 132 can assist the users 102 in interacting with each other to exchange the content 112.

The virtual assistants 132A-132N can communicate with one or more sensors 134A-134N, which can be attached to, embedded within, or worn by the users 102A-102N, respectively. Each of the users 102 can be associated with multiple sensors 134. The sensors 134 can include proximity sensors, temperature sensors, light sensors, air quality sensors, movement sensors, accelerometers, magnetometers, gyroscopes, infrared sensors, orientation sensors, noise sensors, fingerprint sensor, galvanic skin response (“GSV”) sensor, heart rate monitor, eye movement sensor, facial recognition sensor, other biometric sensors, combinations thereof, and/or the like.

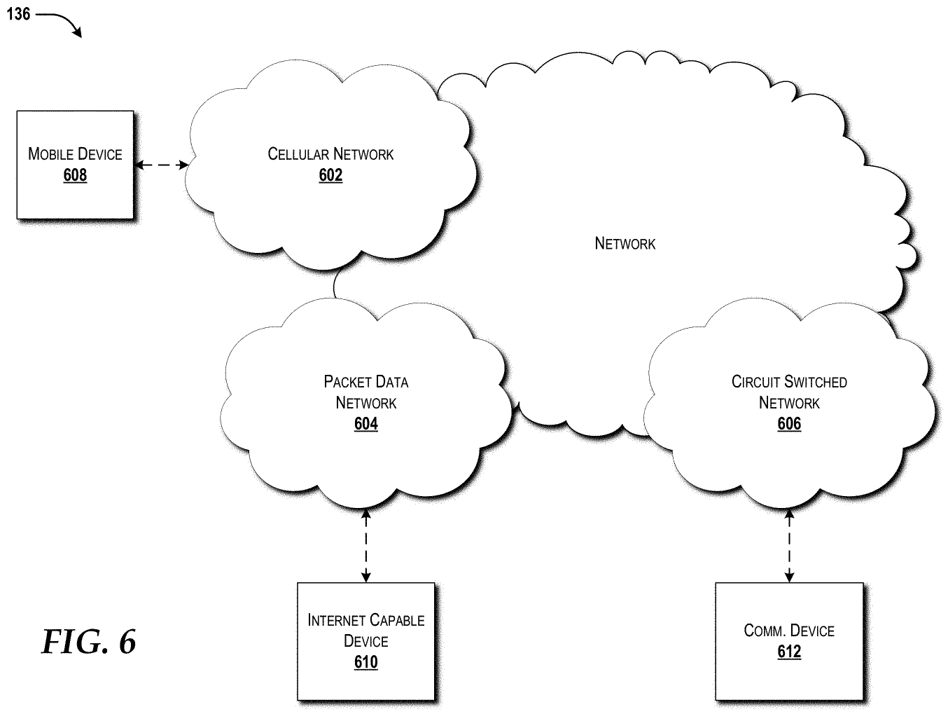

The virtual assistants 132A-132N can also communicate with one or more Internet of Things (“IoT”) devices 136A-136N (hereafter referred to collectively as “IoT devices 136” or individually as “IoT device 136”). The IoT devices 136 can be positioned at various locations within and/or around the physical location 108. The IoT devices 136 can include cameras (e.g., still and/or video), microphones, sensors, and the like. The IoT devices 136 can communicate with the user devices 104 via a direct connection such as, for example, BLUETOOTH or WI-FI DIRECT and/or via a connection with one or more networks 138. The network(s) 138 can be or can include one or more local area networks (“LANs”) such as wireless LAN(s) implemented via WI-FI, one or more wide area networks (“WAN”) such as wireless WAN via cellular technology as described in greater detail herein with reference to FIG. 6.

The virtual assistants 132 can also communicate with one or more presentation devices 140A-140N (hereafter referred to collectively as “presentation devices 140” or individually as “presentation device 140”) such as displays, electronic signs, speakers, and the like. The presentation devices 140 can be used by the virtual assistants 132 to present information associated with the users 102, such as the avatars 114 or any information contained therein, and/or the content 112. The presentation devices 140 can also be used to inform the users 102 of where the avatar group 130 should meet, post current rankings among members of the avatar group 130, highlight certain individuals (e.g., celebrities), and otherwise be used to inform the users 102 of aspects of the event(s) 106 and aspects of the users 102 attending the event(s) 106.

The virtual assistants 132 can communicate over the network(s) 138 with an event management system 142. As noted above, the network(s) 138 can be or can include local and/or wide area networks. As such, the event management system 142 can operate locally within the physical location 108 or remotely from the physical location 108. In some embodiments, the functionality of the event management system 142 is provided by the virtual assistants 132, wherein one of the virtual assistants 132 is designated the event host and the other virtual assistants 132 are designated the event attendees.

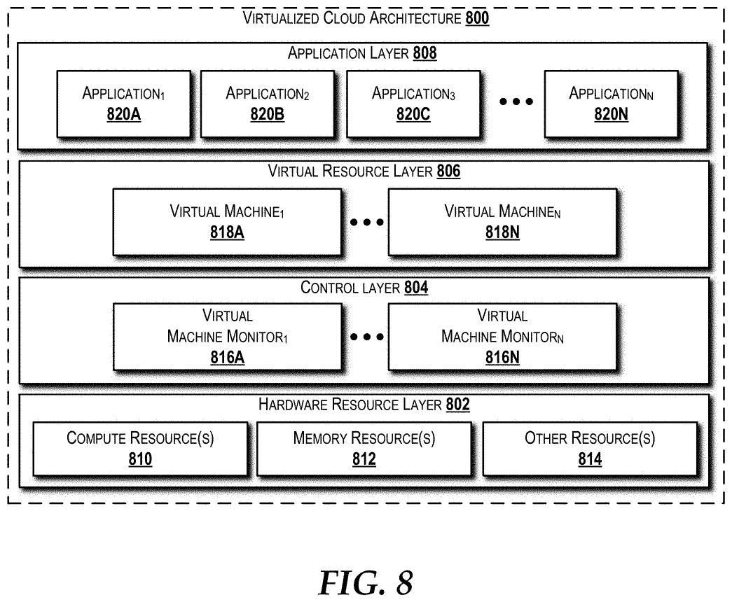

The event management system 142 can utilize an architecture the same as or similar to a computer system 400 that is illustrated and described with reference to FIG. 4. Alternatively, the event management system 142 can utilize an architecture the same as or similar to a mobile device 500 that is illustrated and described with reference to FIG. 5. The event management system 142 can be implemented on a virtualized cloud architecture 800 that is illustrated and described with reference to FIG. 8. The event management system 142 can execute, via one or more processing components (best shown in FIGS. 4, 5, and 8), a plurality of modules, including an event creation and publication module 144, a user identity and avatar management module 146, an avatar group management module 148, a social popularity management module 150, and a privilege management module 152. Although these modules are shown as standalone modules, two or more of these modules can be combined. As such, the illustrated example should not be construed as being limiting in any way.

The event management system 142 can execute the event creation and publication module 144 to create the events 106 based, at least in part, upon the event information 111 obtained from the event host(s) 110. The event management system 142 can store the event information 111 in a calendar, spreadsheet, or other format. The event creation and publication module 144 can also create event invitations 154 to invite one or more of the users 102 to the event(s) 106. The event invitations 154 can be directed to the users 102 based upon information contained in the avatars 114. The event invitations 154 can be provided electronically to the users devices 104 such as via an application notification directed to the virtual assistant 132, an email, a text message, or the like. In response, the event management system 142 can receive one or more event RSVPs 156 that indicate whether or not the users 102 plan to attend the event(s) 106 identified in the event invitations 154. The event RSVPs 156 can additional designate whether the users 102 will attend in-person, virtually, or both. The event invitations 154 alternatively may be published on a website, forum, social media platform, or other Internet space through which the users 102 may proactively provide the event RSVPs 156. In some embodiments, the event invitations 154 can be presented on one or more of the presentation devices 140 as QR codes, web links, or the like.

The users 102 can login to attend the event 106 whether they are attending the event 106 in-person or virtually. The virtual assistants 132 can provide login information 158 to the event management system 142 as part of a login process in preparation for attending the event 106. The login information 158 can uniquely identify the users 102. For example, the login information 158 can include the user identity information 116 to uniquely identify the users 102 to the event management system 142 so that the event management system 142 can match the users 102 attempting to login to the users 102 invited to the event 106. For users 102 who are attending the event 106 in-person, the login process can be triggered upon the users 102 arriving at the physical location 108. Alternatively, the users 102 may provide the login information 158 manually through their respective virtual assistants 132. For users 102 who are attending the event 106 virtually, the login process can be triggered upon the users entering the virtual environment 121, or providing the login information 158 to the event management system 142.

The login information 158 can also include other information contained in the avatars 114. If a user 102 does not have an avatar 114, the login information 158 can specify this and the user identity and avatar management module 146 can create the avatar 114 based upon the login information 158. As additional details are discovered about the user 102, the user identity and avatar management module 146 can update the avatar 114. The user identity and avatar management module 146 can also update the avatars 114 from time-to-time based upon how the users 102 interact with each other, the user devices 104, the sensor(s) 134, the IoT device(s) 136, the presentation device(s) 140, and aspects of the event(s) 106.

The avatar group management module 148 can determine one or more avatar groups 130 based upon information contained in the avatars 114, such as the content markers 126, the interest markers 128, and/or the social markers 131. Each of the avatars 114 may belong to one or more avatar groups 130. The avatars 114 may join the avatar group(s) 130 automatically or may be prompted to do so. The users 102 may initiate, through the virtual assistant 132, the creation of the avatar group(s) 130. In some embodiments, the users 102 associated with the avatars 114 within a given avatar group 130 may share the content 112 as desired via their respective user devices 104 and/or may receive the content 112. The avatar group management module 148 can monitor how the content 112 is being shared and/or interacted with and can modify the avatar group(s) 130 to add or remove avatars 114. Some content 112 may be freely shared outside of the avatar group 130, while other content 112 may be shared upon approval of the avatar group 130. Content sharing can include device-to-device sharing such as the user device₁ 104A sharing the content 112A with the user device₂ 104B or the user device₁ 104A sharing the content 112A with the presentation device₁ 140A.

As the users 102 continue to attend the event 106, the avatar group management module 148 can prompt the virtual assistants 132 with collaboration information 160 that identifies new collaboration opportunities among users 102 within and/or outside of the avatar group 130. The collaboration opportunities can be to form a new avatar group 130, a sub-group within an existing avatar group 130, or a collaboration outside of any avatar group 130. The virtual assistants 132 can present the collaboration information 160 to the users 102. In addition, the virtual assistants 132 may provide collaboration recommendations independent of those identified by the avatar group management module 148. For example, the virtual assistants 132 may identify trends based upon social contributions such as the content 112 being watched, listened to, or otherwise interacted with, “likes” or other feedback, intrinsic popularity based upon participation, and the like. The virtual assistants 132 may identify multiple users 102 watching the same content 112 and suggest a collaboration opportunity in the form of a co-watching event. The IoT devices 136 embodied as cameras, for example, may detect a group of users 102 and notify the virtual assistants 132 associated with that group of users 102 and/or the event management system 142 to suggest a potential collaboration opportunity in the form of creating a new avatar group 130 for the avatars 114 associated with the users 102.

The social popularity management module 150 can maintain rank information 162 for the avatars 114 in attendance at the event 106, within the avatar groups 130, or both. Contributions made by or on behalf of the avatars 114 can be analyzed to determine the rank information 162, including identification of a group leader and other members that have specific tasks within the avatar group 130, such as evangelizing the avatar group 130. In addition to or as an alternative to the rank information 162, the group members can designate a group leader through a voting process. Underperforming group members may be voted out of the avatar group 130.

The privilege management module 152 can provide user privileges 164 to the virtual assistants 132. The user privileges 164 can include credentials to be utilized by the virtual assistants 132 to gain access to the IoT device(s) 136 and/or the presentation device(s) 140. The user privileges 164 can be associated with the content 112 such that only the users 102 that have the necessary user privileges 164 are allowed to access (i.e., watch, listen to, play, etc.) the content 112.

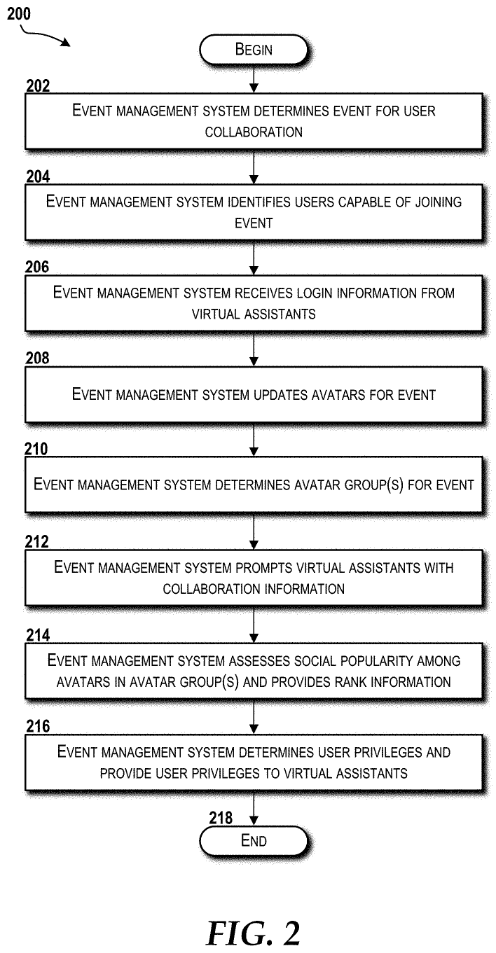

Turning now to FIG. 2, a flow diagram illustrating aspects of a method 200 for the opportunistic creation of bimodal avatar groups 130 from the perspective of the event management system 142 will be described, according to an illustrative embodiment. Although the method 200 will be described in context of a single event 106, the method 200 can be used for multiple events 106 and processed sequentially or simultaneously. It should be understood that the operations of the method disclosed herein is not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the method disclosed herein can be ended at any time and need not be performed in its entirety. Some or all operations of the method, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the methods disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 200 will be described from the perspective of the event management system 142 interacting with the virtual assistants 132 executing on the user devices 104. In some embodiments, the event management system 142 is located on-site at the physical location 108 and can communicate with the virtual assistants 132 over the network 138 embodied, for example, as a WLAN. Alternatively, in other embodiments, the event management system 142 is located off-site from the physical location 108 and can communicate with the virtual assistants 132 over the network 138 embodied, for example, as WWAN. The event management system 142 can communicate with the virtual assistants 132 via multiple networks 138 such as a WWAN and a WLAN.

The method 200 begins and proceeds to operation 202. At operation 202, the event management system 142, via execution of the event creation and publication module 144, determines an event 106 for user collaboration. This determination can be based upon the event information 111 obtained from the event host(s) 110. The event information 111 can define details about the event 106 such as date(s), start times(s), end time(s), duration(s), location(s) (e.g., the physical location 108), physical attendees, virtual attendees, and/or other information associated with the event 106. The event management system 142 can store the event information 111 associated with the event 106 in a calendar, spreadsheet, or other format.

From operation 202, the method 200 proceeds to operation 204. At operation 204, the event management system 142, via execution of the event creation and publication module 144, identifies the users 102 who are capable of joining the event 106. In some embodiments, the event management system 142 can create the event invitations 154 to invite one or more of the users 102 to the event 106. The event invitations 154 can be directed to the users 102 based upon information contained in the avatars 114, such as the user identity information 116. The event invitations 154 can be provided electronically to the users devices 104 such as via an application notification directed to the virtual assistant 132, an email, a text message, or the like. In response, the event management system 142 can receive one or more event RSVPs 156 that indicate whether or not the users 102 plan to attend the event 106 identified in the event invitations 154. In addition, the event RSVP(s) 156 can indicate whether the users 102 plan to attend the event 106 in-person or virtually. The event invitations 154 alternatively may be published on a website, forum, social media platform, or other Internet space through which the users 102 may proactively provide the event RSVPs 156. In some embodiments, the event invitations 154 can be presented on one or more of the presentation devices 140 as QR codes, web links, or the like.

From operation 204, the method 200 proceeds to operation 206. At operation 206, the event management system 142, via execution of the user identity and avatar management module 146, receives the login information 158 from the virtual assistants 132. The users 102 can login to attend the event 106 whether they are attending the event 106 in-person or virtually. The virtual assistants 132 can provide the login information 158 to the event management system 142 as part of a login process in preparation for attending the event 106. The login information 158 can uniquely identify the users 102. For example, the login information 158 can include the user identity information 116 to uniquely identify the users 102 to the event management system 142 so that the event management system 142 can match the users 102 attempting to login to the users 102 invited to the event 106. For the users 102 who plan to attend the event 106 in-person, the login process can be triggered upon the users 102 arriving at the physical location 108. Alternatively, the users 102 may provide the login information 158 manually through their respective virtual assistants 132. For the users 102 who plan to attend the event 106 virtually, the login process can be triggered upon the users 102 providing the login information 158 to the event management system 142 via the virtual assistants 132 or directly to the event management system 142.

From operation 206, the method 200 proceeds to operation 208. At operation 208, the event management system 142, via execution of the user identity and avatar management module 146, updates the avatars 114 for the event 106. This can include updating the user identity information 116, the visual representation 118, the presence identifier 124, the content marker(s) 126, the interest marker(s) 128, and/or the social marker(s) 130 for the event 106. In some embodiments, the login information 158 received at operation 206 can also include the avatars 114. If a user 102 does not have an avatar 114, the login information 158 can specify this and the event management system 142 can create an avatar 114 for the user 102 based upon the login information 158. As additional details are discovered about the user 102, the event management system 142 can update the avatar 114 accordingly. The event management system 142 can also update the avatars 114 from time-to-time based upon how the users 102 interact with each other, the user devices 104, the sensor(s) 134, the IoT device(s) 136, the presentation device(s) 140, and aspects of the event(s) 106.

From operation 208, the method 200 proceeds to operation 210. At operation 210, the event management system 142 determines, via execution of the avatar group management module 148, one or more avatar groups 130 based upon the information contained in the avatars 114. Each of the avatars 114 may belong to one or more avatar groups 130. The avatars 114 may join the avatar group(s) 130 automatically or may be prompted to do so. In some embodiments, the users 102 associated with the avatars 114 within a given avatar group 130 may share the content 112 as desired via their respective user devices 104 and/or may receive the content 112. The event management system 142 can monitor how the content 112 is being shared and/or interacted with and can modify the avatar group(s) 130 to add or remove avatars 114. Some content 112 may be freely shared outside of the avatar group 130, while other content 112 may be shared upon approval of the avatar group 130. Content sharing can include device-to-device sharing such as the user device₁ 104A sharing the content 112A directly with the user device₂ 104B and/or the user device₁ 104A sharing the content 112A with the presentation device₁ 140A.

From operation 210, the method 200 proceeds to operation 212. At operation 212, the event management system 142, via execution of the avatar group management module 148, prompts the virtual assistants 132 with the collaboration information 160 that identifies new collaboration opportunities among users 102 within and/or outside of the avatar group(s) 130 determined at operation 210. The virtual assistants 132 can present the collaboration information 160 to the users 102. In addition, the virtual assistants 132 may provide collaboration recommendations independent of those identified by the avatar group management module 148. For example, the virtual assistants 132 can identify trends based upon social contributions such as the content 112 being watched, listened to, or otherwise interacted with, “likes” or other feedback, intrinsic popularity based upon participation, and the like. The virtual assistants 132 may identify multiple users 102 watching the same content 112 and suggest a collaboration opportunity in the form of a co-watching event.

From operation 212, the method 200 proceeds to operation 214. At operation 214, the event management system 142 assesses, via execution of the social popularity management module 150, the social popularity among the avatars 114 within the avatar group 130. Contributions made by or on behalf of the avatars 114 can be analyzed to determine the rank information 162, including identification of a group leader and other members that have specific tasks within the avatar group 130, such as evangelizing the avatar group 130 to other users 102. In addition to or as an alternative to the rank information 162, the group members can designate a group leader through a voting process. Underperforming group members may be voted out of the avatar group 130.

From operation 214, the method 200 proceeds to operation 216. At operation 216, the event management system 142, via execution of the privilege management module 152 determines the user privileges 164 and provides the user privileges 164 to the virtual assistants 132 for use on behalf of the users 102. The user privileges 164 can include credentials to be utilized by the virtual assistants 132 to gain access to the IoT device(s) 136 and/or the presentation device(s) 140. The user privileges 164 can be associated with the content 112 such that only the users 102 that have the necessary user privileges 164 are allowed to access (i.e., watch, listen to, play, etc.) the content 112.

From operation 216, the method 200 proceeds to operation 218. The method 200 can end at operation 218.

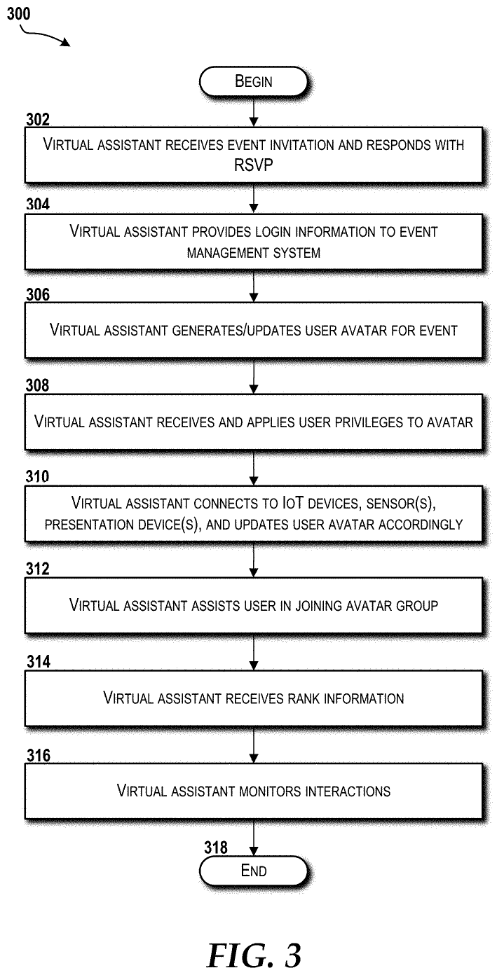

Turning now to FIG. 3, a flow diagram illustrating aspects of a method 300 for the opportunistic creation of bimodal avatar groups 130 from the perspective of the virtual assistant 132 executed by the user device 104 will be described, according to an illustrative embodiment. The method 300 begins and proceeds to operation 302. At operation 302, the virtual assistant 132 receives an event invitation 154 from the event management system 142. Alternatively, the event invitation 154 can originate from another virtual assistant 132. The event invitations 154 can be directed to the user 102 based upon information contained in the avatar 114, such as the user identity information 116. The event invitation 154 can be provided electronically to the users device 104 such as via an application notification directed to the virtual assistant 132, an email, a text message, or the like. In response, the virtual assistant 132 can provide an event RSVP 156 to the event management system 142 (or another virtual assistant 132 as the case may be) that indicates whether or not the user 102 plans to attend the event 106 identified in the event invitation 154. In addition, the event RSVP 156 can indicate whether the user 102 plans to attend the event 106 in-person or virtually. The event invitation 154 alternatively may be published on a website, forum, social media platform, or other Internet space through which the user 102 may proactively provide the event RSVPs 156. In some embodiments, the event invitation 154 can be presented on one or more of the presentation devices 140 as QR codes, web links, or the like.

From operation 302, the method 300 proceeds to operation 304. At operation 304, the virtual assistant 132 provides login information 158 to the event management system 142. The user 102 can login to attend the event 106 whether they are attending the event 106 in-person or virtually. The virtual assistant 132 can provide the login information 158 to the event management system 142 as part of a login process in preparation for attending the event 106. The login information 158 can uniquely identify the user 102. For example, the login information 158 can include the user identity information 116 to uniquely identify the users 102 to the event management system 142 so that the event management system 142 can match the user 102 attempting to login to the users 102 invited to the event 106. For the users 102 who plan to attend the event 106 in-person, the login process can be triggered upon the users 102 arriving at the physical location 108. Alternatively, the users 102 may provide the login information 158 manually through their respective virtual assistants 132. For the users 102 who plant to attend the event 106 virtually, the login process can be triggered upon the users 102 providing the login information 158 to the event management system 142 via the virtual assistants 132.

From operation 304, the method 300 proceeds to operation 306. At operation 306, the virtual assistant 132 generates or updates the avatar 114 for the event 106. This can include updating the user identity information 116, the visual representation 118, the presence identifier 124, the content marker(s) 126, the interest marker(s) 128, and/or the social marker(s) 130 for the event 106. If the user 102 does not have an avatar 114, the login information 158 can specify this and the event management system 142 can create an avatar 114 for the user 102 based upon the login information 158. Alternatively, the virtual assistant 134 can aid the user 102 with creating the avatar 114. The virtual assistant 132 may aid the user 102 with creating the avatar 114 using a template, questionnaire, and/or like. As additional details are discovered about the user 102, the virtual assistant 142 can update the avatar 114 accordingly. The virtual assistant 132 can also update the avatars 114 from time-to-time based upon how the users 102 interact with each other, the user devices 104, the sensor(s) 134, the IoT device(s) 136, the presentation device(s) 140, and aspects of the event(s) 106.

From operation 306, the method 300 proceeds to operation 308. At operation 308, the virtual assistant 132 receives the user privileges 164 from the event management system 142 and applies the user privileges 164 to the avatar 114. The user privileges 164 can include credentials to be utilized by the virtual assistants 132 to gain access to the sensor(s) 134, the IoT device(s) 136, and/or the presentation device(s) 140. The user privileges 164 can be associated with the content 112 such that only the users 102 that have the necessary user privileges 164 are allowed to access (i.e., watch, listen to, play, etc.) the content 112 or share the content 112.

From operation 308, the method 300 proceeds to operation 310. At operation 310, the virtual assistant 132 connects the IoT device(s) 136, the sensor(s) 134, the presentation device(s) 140, or a combination thereof. The virtual assistant 132 can assist the user device 104 in establishing a connection with the IoT device(s) 136, the sensor(s) 134, the presentation device(s) 140, or a combination thereof. The connection can be a direct connection or via the network(s) 138. The virtual assistant 132 may use the user privileges 164 to access the sensor(s) 134, the IoT device(s) 136, and/or the presentation device(s) 140. The virtual assistant 132 may be pre-configured with information about the IoT device(s) 136, the sensor(s) 134, and/or the presentation device(s) 140. In some embodiments, the event invitation 154 can include connection configuration information to enable the virtual assistant 132 to connect to the IoT device(s) 136, the sensor(s) 134, and/or the presentation device(s) 140. The virtual assistant 132 can update the avatar 114 to identity the IoT device(s) 136, the sensor(s) 134, and/or the presentation device(s) 140 with which a connection has been established. The virtual assistant 132 can share the updated avatar 114 with the event management system 142.

From operation 310, the method 300 proceeds to operation 312. At operation 312, the virtual assistant 132 assists the user 102 in joining an avatar group 130. The virtual assistant 132 can receive the collaboration information 160 from the event management system 142. The virtual assistants 132 can present the collaboration information 160 to the user 102. The user 102 can choose whether or not to join the avatar group 130 identified in the collaboration information 160. Alternatively or additionally, the virtual assistant 132 may join the avatar group 130 on behalf of the user 102. The virtual assistant 132 may provide collaboration recommendations independent of those identified by the event management system 142 in the collaboration information 160. For example, the virtual assistants 132 can identify trends based upon social contributions such as the content 112 being watched, listened to, or otherwise interacted with, “likes” or other feedback, intrinsic popularity based upon participation, and the like. The virtual assistants 132 may identify multiple users 102 watching the same content 112 and suggest a collaboration opportunity in the form of a co-watching event.

From operation 312, the method 300 proceeds to operation 314. At operation 314, the virtual assistant 132 receives the rank information 162 from the event management system 142. The rank information 162 can identify the social popularity among the avatars 114 within the avatar group 130. Contributions made by or on behalf of the avatars 114 can be analyzed to determine the rank information 162, including identification of a group leader and other members that have specific tasks within the avatar group 130, such as evangelizing the avatar group 130 to other users 102. In addition to or as an alternative to the rank information 162, the group members can designate a group leader through a voting process. Underperforming group members may be voted out of the avatar group 130.

From operation 314, the method 300 proceeds to operation 316. At operation 316, the virtual assistant 132 monitors interactions. The users 102 interact with each other, the user devices 104, the sensor(s) 134, the IoT device(s) 136, the presentation device(s) 140, and aspects of the event(s) 106. The virtual assistant 132 can monitor these interactions and provide feedback to the event management system 142. The event management system 142 can use the feedback to generate new collaboration information 160, new rank information 162, new user privileges 164, and create or update the avatar groups 130. The virtual assistant 132 can share the content 112 with other virtual assistants 132 on behalf of the avatar 114. The virtual assistant 132 can associate interactions as occurring within the real world (e.g., within the physical location 108) and/or the virtual world (e.g., within the VR environment 121 or via the AR visualizations 123).

From operation 316, the method 300 proceeds to operation 318. The method 300 can end at operation 318.

Turning now to FIG. 4, a block diagram illustrating a computer system 400 configured to provide the functionality described herein in accordance with various embodiments. In some embodiments, the user devices 104 can be configured the same as or similar to the computer system 400. In some embodiments, the event management system 142 can be configured the same as or similar to the computer system 400. In some embodiments, the IoT devices 136 can be configured the same as or similar to the computer system 400. In some embodiments, the presentation devices 140 can be configured the same as or similar to the computer system 400.

The computer system 400 includes a processing unit 402, a memory 404, one or more user interface devices 406, one or more input/output (“I/O”) devices 408, and one or more network devices 410, each of which is operatively connected to a system bus 412. The bus 412 enables bi-directional communication between the processing unit 402, the memory 404, the user interface devices 406, the I/O devices 408, and the network devices 410.

The processing unit 402 may be a standard central processor that performs arithmetic and logical operations, a more specific purpose programmable logic controller (“PLC”), a programmable gate array, or other type of processor known to those skilled in the art and suitable for controlling the operation of the server computer. The processing unit 402 can be a single processing unit or a multiple processing unit that includes more than one processing component. Processing units are generally known, and therefore are not described in further detail herein.

The memory 404 communicates with the processing unit 402 via the system bus 412. The memory 404 can include a single memory component or multiple memory components. In some embodiments, the memory 404 is operatively connected to a memory controller (not shown) that enables communication with the processing unit 402 via the system bus 412. The memory 404 includes an operating system 414 and one or more program modules 416. The operating system 414 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OSX, iOS, and/or families of operating systems from APPLE CORPORATION, the FREEBSD family of operating systems, the SOLARIS family of operating systems from ORACLE CORPORATION, other operating systems, and the like.

The program modules 416 may include various software and/or program modules described herein. The program modules 416 can include the virtual assistant 132 in an embodiment of the user device 104 configured the same as or similar to the computer system 400. The program modules 416 can include the event creation and publication module 144, the user identity and avatar management module 146, the avatar group management module 148, the social popularity management module 150, and the privilege management module in an embodiment of the event management system 142 configured the same as or similar to the computer system 400. In some embodiments, multiple implementations of the computer system 400 can be used, wherein each implementation is configured to execute one or more of the program modules 416. The program modules 416 and/or other programs can be embodied in computer-readable media containing instructions that, when executed by the processing unit 402, perform the method 200 and/or the method 300 described herein. According to embodiments, the program modules 416 may be embodied in hardware, software, firmware, or any combination thereof. The memory 404 also can be configured to store the avatar 114, the user identity information 116, the visual representation 118, the presence identifier 124, the content markers 126, the interest markers 128, the social markers 131, the event information 111, the event invitations 154, the event RSVPs 156, the collaboration information 160, the rank information 162, the user privileges 164, the login information 158, the content 112, other data disclosed herein, or a combination thereof.

By way of example, and not limitation, computer-readable media may include any available computer storage media or communication media that can be accessed by the computer system 400. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 400. In the claims, the phrase “computer storage medium,” “computer-readable storage medium,” and variations thereof does not include waves or signals per se and/or communication media, and therefore should be construed as being directed to “non-transitory” media only.

The user interface devices 406 may include one or more devices with which a user accesses the computer system 400. The user interface devices 406 may include, but are not limited to, computers, servers, personal digital assistants, cellular phones, or any suitable computing devices. The I/O devices 408 enable a user to interface with the program modules 416. In one embodiment, the I/O devices 408 are operatively connected to an I/O controller (not shown) that enables communication with the processing unit 402 via the system bus 412. The I/O devices 408 may include one or more input devices, such as, but not limited to, a keyboard, a mouse, or an electronic stylus. Further, the I/O devices 408 may include one or more output devices, such as, but not limited to, a display or printer.

The network devices 410 enable the computer system 400 to communicate with other networks or remote systems via the network(s) 418. Examples of the network devices 410 include, but are not limited to, a modem, a radio frequency (“RF”) or infrared (“IR”) transceiver, a telephonic interface, a bridge, a router, or a network card. The network 418 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 418 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Turning now to FIG. 5, an illustrative mobile device 500 and components thereof will be described. In some embodiments, the user devices 104 can be configured the same as or similar to the mobile device 500. In some embodiments, the event management system 142 can be configured the same as or similar to the mobile device 500. In some embodiments, the IoT devices 136 can be configured the same as or similar to the mobile device 500. In some embodiments, the presentation devices 140 can be configured the same as or similar to the mobile device 500. While connections are not shown between the various components illustrated in FIG. 5, it should be understood that some, none, or all of the components illustrated in FIG. 5 can be configured to interact with one another to carry out various device functions. In some embodiments, the components are arranged so as to communicate via one or more busses (not shown). Thus, it should be understood that FIG. 5 and the following description are intended to provide a general understanding of a suitable environment in which various aspects of embodiments can be implemented, and should not be construed as being limiting in any way.

As illustrated in FIG. 5, the mobile device 500 can include a display 502 for displaying data. In some embodiments, the display 502 is or includes the video output device(s) 162. According to various embodiments, the display 502 can be configured to display various GUI elements, text, images, video, virtual keypads and/or keyboards, messaging data, notification messages, metadata, Internet content, device status, time, date, calendar data, device preferences, map and location data, combinations thereof, and/or the like. The mobile device 500 can also include a processor 504 and a memory or other data storage device (“memory”) 506. The processor 504 can be configured to process data and/or can execute computer-executable instructions stored in the memory 506. The computer-executable instructions executed by the processor 504 can include, for example, an operating system 508, one or more applications 510, other computer-executable instructions stored in the memory 506, or the like. The applications 510 can include the The program modules 416 can include the virtual assistant 132 in an embodiment of the user device 104 configured the same as or similar to the computer system 400. The program modules 416 can include the event creation and publication module 144, the user identity and avatar management module 146, the avatar group management module 148, the social popularity management module 150, the privilege management module 152, or a combination thereof. In some embodiments, the applications 510 can also include a UI application (not illustrated in FIG. 5). The memory 506 can also store the avatar 114, the user identity information 116, the visual representation 118, the presence identifier 124, the content markers 126, the interest markers 128, the social markers 131, the event information 111, the event invitations 154, the event RSVPs 156, the collaboration information 160, the rank information 162, the user privileges 164, the login information 158, the content 112, other data disclosed herein, or a combination thereof.

The UI application can interface with the operating system 508 to facilitate user interaction with functionality and/or data stored at the mobile device 500 and/or stored elsewhere. In some embodiments, the operating system 508 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE LLC, and/or other operating systems. These operating systems are merely illustrative of some contemplated operating systems that may be used in accordance with various embodiments of the concepts and technologies described herein and therefore should not be construed as being limiting in any way.

The UI application can be executed by the processor 504 to aid a user in entering/deleting data, entering and setting user IDs and passwords for device access, configuring settings, manipulating content and/or settings, multimode interaction, interacting with other applications 510, and otherwise facilitating user interaction with the operating system 508, the applications 510, and/or other types or instances of data 512 that can be stored at the mobile device 500.

The applications 510, the data 512, and/or portions thereof can be stored in the memory 506 and/or in a firmware 514, and can be executed by the processor 504. The firmware 514 can also store code for execution during device power up and power down operations. It can be appreciated that the firmware 514 can be stored in a volatile or non-volatile data storage device including, but not limited to, the memory 506 and/or a portion thereof.

The mobile device 500 can also include an input/output (“I/O”) interface 516. The I/O interface 516 can be configured to support the input/output of data such as location information, presence status information, user IDs, passwords, and application initiation (start-up) requests. In some embodiments, the I/O interface 516 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 500 can be configured to synchronize with another device to transfer content to and/or from the mobile device 500. In some embodiments, the mobile device 500 can be configured to receive updates to one or more of the applications 510 via the I/O interface 516, though this is not necessarily the case. In some embodiments, the I/O interface 516 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 516 may be used for communications between the mobile device 500 and a network device or local device.

The mobile device 500 can also include a communications component 518. The communications component 518 can be configured to interface with the processor 504 to facilitate wired and/or wireless communications with one or more networks, such as the network 418, the Internet, or some combination thereof. In some embodiments, the communications component 518 includes a multimode communications subsystem for facilitating communications via the cellular network and one or more other networks.

The communications component 518, in some embodiments, includes one or more transceivers. The one or more transceivers, if included, can be configured to communicate over the same and/or different wireless technology standards with respect to one another. For example, in some embodiments, one or more of the transceivers of the communications component 518 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.5G, 3G, 4G, 4.5G, 5G, and greater generation technology standards. Moreover, the communications component 518 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 518 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 518 can include a first transceiver (“TxRx”) 520A that can operate in a first communications mode (e.g., GSM). The communications component 518 can also include an N^{th} transceiver (“TxRx”) 520N that can operate in a second communications mode relative to the first transceiver 520A (e.g., UMTS). While two transceivers 520A-520N (hereinafter collectively and/or generically referred to as “transceivers 520”) are shown in FIG. 5, it should be appreciated that less than two, two, and/or more than two transceivers 520 can be included in the communications component 518.

The communications component 518 can also include an alternative transceiver (“Alt TxRx”) 522 for supporting other types and/or standards of communications. According to various contemplated embodiments, the alternative transceiver 522 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 518 can also facilitate reception from terrestrial radio networks, digital satellite radio networks, internet-based radio service networks, combinations thereof, and the like. The communications component 518 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 500 can also include one or more sensors 524. The sensors 524 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 500 may be provided by an audio I/O component 526. The audio I/O component 526 of the mobile device 500 can include one or more speakers for the output of audio signals, one or more microphones for the collection and/or input of audio signals, and/or other audio input and/or output devices.

The illustrated mobile device 500 can also include a subscriber identity module (“SIM”) system 528. The SIM system 528 can include a universal SIM (“USIM”), a universal integrated circuit card (“UICC”) and/or other identity devices. The SIM system 528 can include and/or can be connected to or inserted into an interface such as a slot interface 530. In some embodiments, the slot interface 530 can be configured to accept insertion of other identity cards or modules for accessing various types of networks. Additionally, or alternatively, the slot interface 530 can be configured to accept multiple subscriber identity cards. Because other devices and/or modules for identifying users and/or the mobile device 500 are contemplated, it should be understood that these embodiments are illustrative, and should not be construed as being limiting in any way.

The mobile device 500 can also include an image capture and processing system 532 (“image system”). The image system 532 can be configured to capture or otherwise obtain photos, videos, and/or other visual information. As such, the image system 532 can include cameras, lenses, charge-coupled devices (“CCDs”), combinations thereof, or the like. The mobile device 500 may also include a video system 534. The video system 534 can be configured to capture, process, record, modify, and/or store video content. Photos and videos obtained using the image system 532 and the video system 534, respectively, may be added as message content to an MMS message, email message, and sent to another device. The video and/or photo content can also be shared with other devices via various types of data transfers via wired and/or wireless communication devices as described herein.

The mobile device 500 can also include one or more location components 536. The location components 536 can be configured to send and/or receive signals to determine a geographic location of the mobile device 500. According to various embodiments, the location components 536 can send and/or receive signals from global positioning system (“GPS”) devices, assisted-GPS (“A-GPS”) devices, WI-FI/WIMAX and/or cellular network triangulation data, combinations thereof, and the like. The location component 536 can also be configured to communicate with the communications component 518 to retrieve triangulation data for determining a location of the mobile device 500. In some embodiments, the location component 536 can interface with cellular network nodes, telephone lines, satellites, location transmitters and/or beacons, wireless network transmitters and receivers, combinations thereof, and the like. In some embodiments, the location component 536 can include and/or can communicate with one or more of the sensors 524 such as a compass, an accelerometer, and/or a gyroscope to determine the orientation of the mobile device 500. Using the location component 536, the mobile device 500 can generate and/or receive data to identify its geographic location, or to transmit data used by other devices to determine the location of the mobile device 500. The location component 536 may include multiple components for determining the location and/or orientation of the mobile device 500.

The illustrated mobile device 500 can also include a power source 538. The power source 538 can include one or more batteries, power supplies, power cells, and/or other power subsystems including alternating current (“AC”) and/or direct current (“DC”) power devices. The power source 538 can also interface with an external power system or charging equipment via a power I/O component 540. Because the mobile device 500 can include additional and/or alternative components, the above embodiment should be understood as being illustrative of one possible operating environment for various embodiments of the concepts and technologies described herein. The described embodiment of the mobile device 500 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 500 or other devices or computers described herein, such as the computer system 400 described above with reference to FIG. 4. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 500 in order to store and execute the software components presented herein. It is also contemplated that the mobile device 500 may not include all of the components shown in FIG. 5, may include other components that are not explicitly shown in FIG. 5, or may utilize an architecture completely different than that shown in FIG. 5.

Turning now to FIG. 6, details of a network 600 are illustrated, according to an illustrative embodiment. In some embodiments, the network(s) 138 shown in FIG. 1 and/or the network 418 shown in FIG. 4 can be configured the same as or similar to the network 600. The network 600 includes a cellular network 602, a packet data network 604, and a circuit switched network 606 (e.g., a public switched telephone network). The cellular network 602 includes various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 602 also includes radios and nodes for receiving and transmitting voice, data, and combinations thereof to and from radio transceivers, networks, the packet data network 604, and the circuit switched network 606.

A mobile communications device 608, such as, for example, the mobile device 500, a cellular telephone, a user equipment, a mobile terminal, a PDA, a laptop computer, a handheld computer, and combinations thereof, can be operatively connected to the cellular network 602. The mobile communications device 608 can be configured similar to or the same as the mobile device 500 described above with reference to FIG. 5.

The cellular network 602 can be configured as a GSM network and can provide data communications via GPRS and/or EDGE. Additionally, or alternatively, the cellular network 602 can be configured as a 3G Universal Mobile Telecommunications System (“UMTS”) network and can provide data communications via the HSPA protocol family, for example, HSDPA, EUL, and HSPA+. The cellular network 602 also is compatible with mobile communications standards such as LTE, or the like, as well as evolved and future mobile standards.

The packet data network 604 includes various systems, devices, servers, computers, databases, and other devices in communication with one another, as is generally known. The user device(s) 104, the event management system 142, the IoT device(s) 136, the presentation device(s) 140, or some combination thereof can communicate with each other via the packet data network 604. In some embodiments, the packet data network 604 is or includes one or more WI-FI networks, each of which can include one or more WI-FI access points, routers, switches, and other WI-FI network components. The packet data network 604 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 604 includes or is in communication with the Internet. The circuit switched network 606 includes various hardware and software for providing circuit switched communications. The circuit switched network 606 may include, or may be, what is often referred to as a plain old telephone system (“POTS”). The functionality of a circuit switched network 606 or other circuit-switched network are generally known and will not be described herein in detail.

The illustrated cellular network 602 is shown in communication with the packet data network 604 and a circuit switched network 606, though it should be appreciated that this is not necessarily the case. One or more Internet-capable systems/devices 610 such as the user device(s) 104, the event management system 142, the IoT device(s) 136, the presentation device(s) 140, a laptop, a portable device, or another suitable device, can communicate with one or more cellular networks 602, and devices connected thereto, through the packet data network 604. It also should be appreciated that the Internet-capable device 610 can communicate with the packet data network 604 through the circuit switched network 606, the cellular network 602, and/or via other networks (not illustrated).

As illustrated, a communications device 612, for example, a telephone, facsimile machine, modem, computer, or the like, can be in communication with the circuit switched network 606, and therethrough to the packet data network 604 and/or the cellular network 602. It should be appreciated that the communications device 612 can be an Internet-capable device, and can be substantially similar to the Internet-capable device 610.

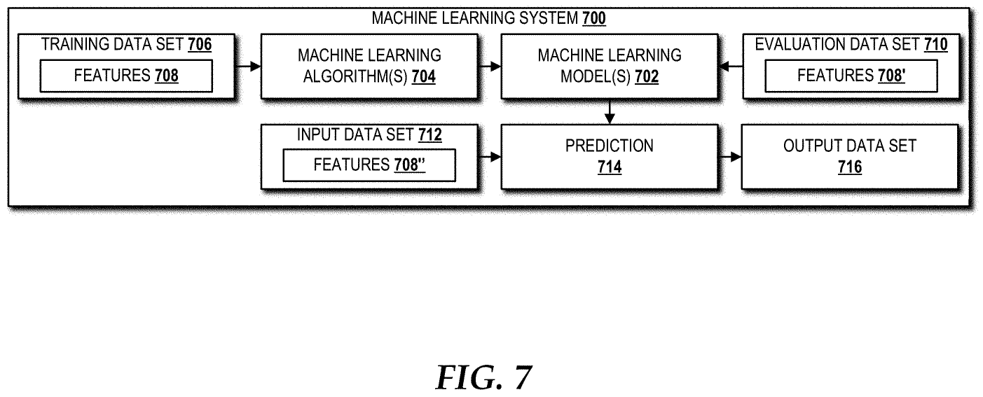

Turning now to FIG. 7, a machine learning system 700 capable of implementing aspects of the embodiments disclosed herein will be described. In some embodiments, aspects of the user device(s) 104, the event management system 142, the IoT device(s) 136, the presentation device(s) 140, or a combination thereof can be improved via machine learning. Accordingly, the user device(s) 104, the event management system 142, the IoT device(s) 136, the presentation device(s) 140, or a combination thereof can include or can be in communication with a machine learning system 700 or multiple machine learning systems 700.

The illustrated machine learning system 700 includes one or more machine learning models 702. The machine learning models 702 can include, unsupervised, supervised, and/or semi-supervised learning models. The machine learning model(s) 702 can be created by the machine learning system 700 based upon one or more machine learning algorithms 704. The machine learning algorithm(s) 704 can be any existing, well-known algorithm, any proprietary algorithms, or any future machine learning algorithm. Some example machine learning algorithms 704 include, but are not limited to, neural networks, gradient descent, linear regression, logistic regression, linear discriminant analysis, classification tree, regression tree, Naive Bayes, K-nearest neighbor, learning vector quantization, support vector machines, any of the algorithms described herein, and the like. Classification and regression algorithms might find particular applicability to the concepts and technologies disclosed herein. Those skilled in the art will appreciate the applicability of various machine learning algorithms 704 based upon the problem(s) to be solved by machine learning via the machine learning system 700.

The machine learning system 700 can control the creation of the machine learning models 702 via one or more training parameters. In some embodiments, the training parameters are selected modelers at the direction of an enterprise, for example. Alternatively, in some embodiments, the training parameters are automatically selected based upon data provided in one or more training data sets 706. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 704 converges to the optimal weights. The machine learning algorithm 704 can update the weights for every data example included in the training data set 706. The size of an update is controlled by the learning rate. A learning rate that is too high might prevent the machine learning algorithm 704 from converging to the optimal weights. A learning rate that is too low might result in the machine learning algorithm 704 requiring multiple training passes to converge to the optimal weights.

The model size is regulated by the number of input features (“features”) 708 in the training data set 706. A greater the number of features 708 yields a greater number of possible patterns that can be determined from the training data set 706. The model size should be selected to balance the resources (e.g., compute, memory, storage, etc.) needed for training and the predictive power of the resultant machine learning model 702.

The number of training passes indicates the number of training passes that the machine learning algorithm 704 makes over the training data set 706 during the training process. The number of training passes can be adjusted based, for example, on the size of the training data set 706, with larger training data sets being exposed to fewer training passes in consideration of time and/or resource utilization. The effectiveness of the resultant machine learning model 702 can be increased by multiple training passes.

Data shuffling is a training parameter designed to prevent the machine learning algorithm 704 from reaching false optimal weights due to the order in which data contained in the training data set 706 is processed. For example, data provided in rows and columns might be analyzed first row, second row, third row, etc., and thus an optimal weight might be obtained well before a full range of data has been considered. By data shuffling, the data contained in the training data set 706 can be analyzed more thoroughly and mitigate bias in the resultant machine learning model 702.

Regularization is a training parameter that helps to prevent the machine learning model 702 from memorizing training data from the training data set 706. In other words, the machine learning model 702 fits the training data set 706, but the predictive performance of the machine learning model 702 is not acceptable. Regularization helps the machine learning system 700 avoid this overfitting/memorization problem by adjusting extreme weight values of the features 708. For example, a feature that has a small weight value relative to the weight values of the other features in the training data set 706 can be adjusted to zero.

The machine learning system 700 can determine model accuracy after training by using one or more evaluation data sets 710 containing the same features 708′ as the features 708 in the training data set 706. This also prevents the machine learning model 702 from simply memorizing the data contained in the training data set 706. The number of evaluation passes made by the machine learning system 700 can be regulated by a target model accuracy that, when reached, ends the evaluation process and the machine learning model 702 is considered ready for deployment.

After deployment, the machine learning model 702 can perform a prediction operation (“prediction”) 714 with an input data set 712 having the same features 708″ as the features 708 in the training data set 706 and the features 708′ of the evaluation data set 710. The results of the prediction 714 are included in an output data set 716 consisting of predicted data. The machine learning model 702 can perform other operations, such as regression, classification, and others. As such, the example illustrated in FIG. 7 should not be construed as being limiting in any way.

Turning now to FIG. 8, a block diagram illustrating an example virtualized cloud architecture 800 and components thereof will be described, according to an exemplary embodiment. In some embodiments, the virtualized cloud architecture 800 can be utilized to implement, at least in part, the event management system 142, the network 600 or a portion thereof. The virtualized cloud architecture 800 is a shared infrastructure that can support multiple services and network applications. The illustrated virtualized cloud architecture 800 includes a hardware resource layer 802, a control layer 804, a virtual resource layer 806, and an application layer 808 that work together to perform operations as will be described in detail herein.

The hardware resource layer 802 provides hardware resources, which, in the illustrated embodiment, include one or more compute resources 810, one or more memory resources 812, and one or more other resources 814. The compute resource(s) 810 can include one or more hardware components that perform computations to process data, and/or to execute computer-executable instructions of one or more application programs, operating systems, and/or other software. The compute resources 810 can include one or more central processing units (“CPUs”) configured with one or more processing cores. The compute resources 810 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 810 can include one or more discrete GPUs. In some other embodiments, the compute resources 810 can include CPU and GPU components that are configured in accordance with a co-processing CPU/GPU computing model, wherein the sequential part of an application executes on the CPU and the computationally-intensive part is accelerated by the GPU. The compute resources 810 can include one or more system-on-chip (“SoC”) components along with one or more other components, including, for example, one or more of the memory resources 812, and/or one or more of the other resources 814. In some embodiments, the compute resources 810 can be or can include one or more SNAPDRAGON SoCs, available from QUALCOMM; one or more TEGRA SoCs, available from NVIDIA; one or more HUMMINGBIRD SoCs, available from SAMSUNG; one or more Open Multimedia Application Platform (“OMAP”) SoCs, available from TEXAS INSTRUMENTS; one or more customized versions of any of the above SoCs; and/or one or more proprietary SoCs. The compute resources 810 can be or can include one or more hardware components architected in accordance with an advanced reduced instruction set computing (“RISC”) machine (“ARM”) architecture, available for license from ARM HOLDINGS. Alternatively, the compute resources 810 can be or can include one or more hardware components architected in accordance with an x86 architecture, such an architecture available from INTEL CORPORATION of Mountain View, Calif., and others. Those skilled in the art will appreciate the implementation of the compute resources 810 can utilize various computation architectures, and as such, the compute resources 810 should not be construed as being limited to any particular computation architecture or combination of computation architectures, including those explicitly disclosed herein.

The memory resource(s) 812 can include one or more hardware components that perform storage operations, including temporary or permanent storage operations. In some embodiments, the memory resource(s) 812 include volatile and/or non-volatile memory implemented in any method or technology for storage of information such as computer-readable instructions, data structures, program modules, or other data disclosed herein. In implementations of the event management system 142 on the virtualized cloud architecture 800, the memory resource(s) 812 can store the event creation and publication module 144, the user identity and avatar management module 146, the avatar group management module 148, the social popularity management module 150, the privilege management module 152, or a combination thereof. The memory resources(s) 812 can also store the avatar 114, the user identity information 116, the visual representation 118, the presence identifier 124, the content markers 126, the interest markers 128, the social markers 131, the event information 111, the event invitations 154, the event RSVPs 156, the collaboration information 160, the rank information 162, the user privileges 164, the login information 158, the content 112, other data disclosed herein, or a combination thereof.

Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 810.

The other resource(s) 814 can include any other hardware resources that can be utilized by the compute resources(s) 810 and/or the memory resource(s) 812 to perform operations described herein. The other resource(s) 814 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 802 can be virtualized by one or more virtual machine monitors (“VMMs”) 816A-816N (also known as “hypervisors”; hereinafter “VMMs 816”) operating within the control layer 804 to manage one or more virtual resources that reside in the virtual resource layer 806. The VMMs 816 can be or can include software, firmware, and/or hardware that alone or in combination with other software, firmware, and/or hardware, manages one or more virtual resources operating within the virtual resource layer 806.

The virtual resources operating within the virtual resource layer 806 can include abstractions of at least a portion of the compute resources 810, the memory resources 812, the other resources 814, or any combination thereof. These abstractions are referred to herein as virtual machines (“VMs”). In the illustrated embodiment, the virtual resource layer 806 includes VMs 818A-818N (hereinafter “VMs 818”). Each of the VMs 818 can execute one or more applications 820A-820N in the application layer 808.

Based on the foregoing, it should be appreciated that aspects of opportunistic creation of bimodal avatar groups have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
receiving, by a virtual assistant executed by a processor of a user device, an event invitation, wherein the event invitation identifies an event to which a user associated with the user device is invited;
providing, by the virtual assistant, an event RSVP in response to the event invitation, wherein the event RSVP indicates whether the user plans to attend the event;
obtaining, by the virtual assistant, an avatar associated with the user, wherein the avatar comprises user identity information that uniquely identifies the user for the event; and
assisting, by the virtual assistant, the avatar in joining an avatar group comprising a plurality of avatars, wherein the plurality of avatars comprises the avatar of the user.

2. The method of claim 1, wherein:
receiving, by the virtual assistant, the event invitation comprises receiving, by the virtual assistant, the event invitation from an event management system; and
providing, by the virtual assistant, the event RSVP to the event management system in response to the event invitation.

3. The method of claim 1, wherein:
receiving, by the virtual assistant, the event invitation comprises receiving, by the virtual assistant, the event invitation from a second virtual assistant, wherein the second virtual assistant is executed by a second processor associated with a second user device; and
providing, by the virtual assistant, the event RSVP to the second virtual assistant in response to the event invitation.

4. The method of claim 1, wherein the event comprises a real-world component and a virtual world component.

5. The method of claim 4, wherein the event RSVP further indicates whether the user plans to attend the real-world component, the virtual world component, or both.

6. The method of claim 5, wherein:
the plurality of avatars further comprises a second avatar of a second user;
the user attends the real-world component of the event; and
the second user attends the virtual world component of the event.

7. The method of claim 6, wherein:
the avatar further comprises a visual representation of the user;
the second avatar comprises a second visual representation of the second user;
the visual representation of the user is presented to the second user in the virtual world component; and
the second visual representation of the second user is presented to the user in the real-world component.

8. The method of claim 7, wherein the second visual representation of the second user is presented to the user via the user device, a presentation device located within a physical location associated with the event, or via an augmented reality visualization.

9. The method of claim 1, wherein assisting, by the virtual assistant, the avatar in joining the avatar group comprises:
receiving collaboration information that identifies a new collaboration opportunity, wherein the new collaboration opportunity is among a plurality of users associated with the plurality of avatars; and
recommending, to the user, to accept the new collaboration opportunity and join the avatar group.

10. The method of claim 9, wherein the new collaboration opportunity is based on a content.

11. A user device comprising:
a processor; and
a memory comprising instructions that, when executed by the processor, cause the processor to perform operations comprising
receiving an event invitation, wherein the event invitation identifies an event to which a user associated with the user device is invited,
providing an event RSVP in response to the event invitation, wherein the event RSVP indicates whether the user plans to attend the event,
obtaining an avatar associated with the user, wherein the avatar comprises user identity information that uniquely identifies the user for the event, and
assisting the avatar in joining an avatar group comprising a plurality of avatars, wherein the plurality of avatars comprises the avatar of the user.

12. The user device of claim 11, wherein the event comprises a real-world component and a virtual world component.

13. The user device of claim 12, wherein the event RSVP further indicates whether the user plans to attend the real-world component, the virtual world component, or both.

14. The user device of claim 13, wherein:
the plurality of avatars further comprises a second avatar of a second user;
the user attends the real-world component of the event; and
the second user attends the virtual world component of the event.

15. The user device of claim 14, wherein:
the avatar further comprises a visual representation of the user;
the second avatar comprises a second visual representation of the second user;
the visual representation of the user is presented to the second user in the virtual world component; and
the second visual representation of the second user is presented to the user in the real-world component.

16. The user device of claim 11, wherein assisting the avatar in joining the avatar group comprises:
receiving collaboration information that identifies a new collaboration opportunity, wherein the new collaboration opportunity is among a plurality of users associated with the plurality of avatars; and
recommending, to the user, to accept the new collaboration opportunity and join the avatar group.

17. The user device of claim 16, wherein the new collaboration opportunity is based on a content.

18. A computer-readable storage medium comprising computer-executable instructions that, when executed by a processor of a user device, cause the processor to perform operations comprising:
receiving an event invitation, wherein the event invitation identifies an event to which a user associated with the user device is invited;
providing an event RSVP in response to the event invitation, wherein the event RSVP indicates whether the user plans to attend the event;
obtaining an avatar associated with the user, wherein the avatar comprises user identity information that uniquely identifies the user for the event; and
assisting the avatar in joining an avatar group comprising a plurality of avatars, wherein the plurality of avatars comprises the avatar of the user.

19. The computer-readable storage medium of claim 18, wherein the operations further comprise:
determining a user privilege for the user, wherein the user privilege is associated with a content; and
allowing the user to access the content in accordance with the user privilege.

20. The computer-readable storage medium of claim 18, wherein the operations further comprise determining rank information for the avatar group, wherein the rank information identifies a group leader of the avatar group; and wherein assisting the avatar in joining the avatar group comprises:
receiving collaboration information that identifies a new collaboration opportunity around a preferred content specified by the group leader, wherein the new collaboration opportunity is among a plurality of users associated with the plurality of avatars in the avatar group; and
recommending, to the user, to accept the new collaboration opportunity and join the avatar group.
